(19) United States
(12) Patent Application Publication
(10) Pub. No.: US 2013/0206187 A1
(43) Pub. Date: Aug. 15, 2013

(54) TREATMENT SYSTEM FOR A GARBAGE DISPOSAL AND SINK DRAIN PIPE

(71) Applicant: Disposal Guard Inc., (US)

(72) Inventor: Thomas K. Dombrowski, Elk Grove Village, IL (US)

(73) Assignee: DISPOSAL GUARD INC., Elk Grove Village, IL (US)

(21) Appl. No.: 13/744,769

(22) Filed: Jan. 18, 2013

Related U.S. Application Data
(60) Provisional application No. 61/596,866, filed on Feb. 9, 2012.

(51) Int. Cl. B08B 3/04

(52) U.S. Cl. CPC B08B 3/04
USPC 134/169 R

(57) ABSTRACT

A garbage disposal treatment system, preferably for use with a double basin sink comprising first and second basins, a garage disposal mounted under the first basin and a sink drain pipe mounted under the second basin and having a P-trap is provided. The treatment system comprises a refillable reservoir for holding sanitizing liquid, an electrically powered pump for pumping the liquid into the garbage disposal so that the liquid impinges on the garbage disposal blades and splashguard, and switch for activating the pump. The treatment system may also pump liquid into the sink drain pipe of the second sink.

### BACKGROUND

1. Field of The Invention

This patent relates to a system for treating a garbage disposal and, optionally, an adjoining sink drain pipe.

2. Description of the Related Art

Garbage disposals and kitchen sink drain pipes can become contaminated with food particles, resulting in unpleasant odors that can disseminate back into the kitchen. Numerous methods of dealing with this problem have been proposed, perhaps the most common being to pour baking soda (sodium bicarbonate) down the drain. While this method may provide a temporary solution to a drain odor problem, the baking soda is quickly washes away once water is introduced into the drain. Also, the baking soda does not always reach the areas inside the garbage disposal and drain that need sanitizing.

Other methods of deodorizing and or sanitizing sink drains have been proposed. For example, Gangloff U.S. Pat. No. 2,542,367 describes a device that fits in the trap of a sink drain and can be heated as needed to clean the drain trap. The heating effect can sanitize the drain by killing organisms.

Roth U.S. Pat. No. 4,910,808 describes a device that dispenses a flowable deodorizing chemical from a pressurized container into the inside of a grinder type garbage disposal system.

Richter U.S. Pat. No. 6,197,321 describes a solid granular chemical drain treatment product that fits above a sink drain. The chemical slowly dissolves under contact with drain water.

Scuilla U.S. Pat. No. 6,558,538 describes a rod-shaped device that can be dropped down into the area within a U-shaped sink trap to sanitize the drain. The device is a porous container which holds a chemical deodorizer that can slowly dissolve. The device is held in place by a tether.

All of these methods involve complicated solutions to the problem of drain odors. Thus there remains a need for a simple, effective way to deodorize and/or sanitize a garbage disposal and an adjoining sink drain pipe. Further and additional objects will appear from the description, accompanying drawings, and appended claims.

### SUMMARY OF THE INVENTION

The present invention is a treatment system, preferably for use with a double basin sink comprising first and second basins, a garbage disposal mounted under the first basin and a sink drain pipe mounted under the second basin and having a P-trap, wherein the system comprises a reservoir for holding liquid; an electrically powered pump for pumping the liquid into the garbage disposal; and switch for activating the pump. The treatment system may also pump liquid into the drain pipe under the second sink.

The reservoir may be removably mounted within a mounting bracket located under the sink. The treatment system may further comprise a first conduit extending between and connecting the reservoir to the pump, and a second conduit extending between the pump and one or more nozzles located inside the garbage disposal.

The liquid may comprise a sanitizing compound, a deodorizing compound and a degreasing compound. The treatment system may further comprise a light indicator to indicate a low level of liquid in the reservoir.

The treatment system may further comprise a third conduit extending between the pump and the drain pipe located under the second sink. More specifically, the third conduit may extend between the pump and one or more nozzles located within the drain pipe above a P-trap.

In one embodiment the switch has an “on” position and an “off” position, and the pump is activated for only as long as the switch is in the “on” position.

In another embodiment the switch has an “on” position and an “off” position, and the system further comprises a timer which automatically activates the pump during operation of the garbage disposal when the switch is in the “on” position.

In still another embodiment the switch has an “on” position and an “off” position, and the system further comprises a timer which activates the pump a predetermined period of time after the garbage disposal has been operated when the switch is in the “on” position.

In yet another embodiment the switch has an “on” position and an “off” position, and the system further comprises a timer which activates system periodically when the switch is in the “on” position. The timer can be set to activate the pump daily, after every two days or after any suitable period of time.

### THE DRAWINGS

FIG. 1 is a perspective view of a double basin sink equipped with a garbage disposal and the treatment system of the present invention, with the garbage disposal shown in cutaway view to reveal part of the treatment system.

### DETAILED DESCRIPTION OF THE INVENTION

While this invention may be embodied in many forms, there is shown in the drawings and will herein be described in detail one or more embodiments, with the understanding that this disclosure is to be considered an exemplification of the principles of the invention and is not intended to limit the invention to the illustrated embodiments.

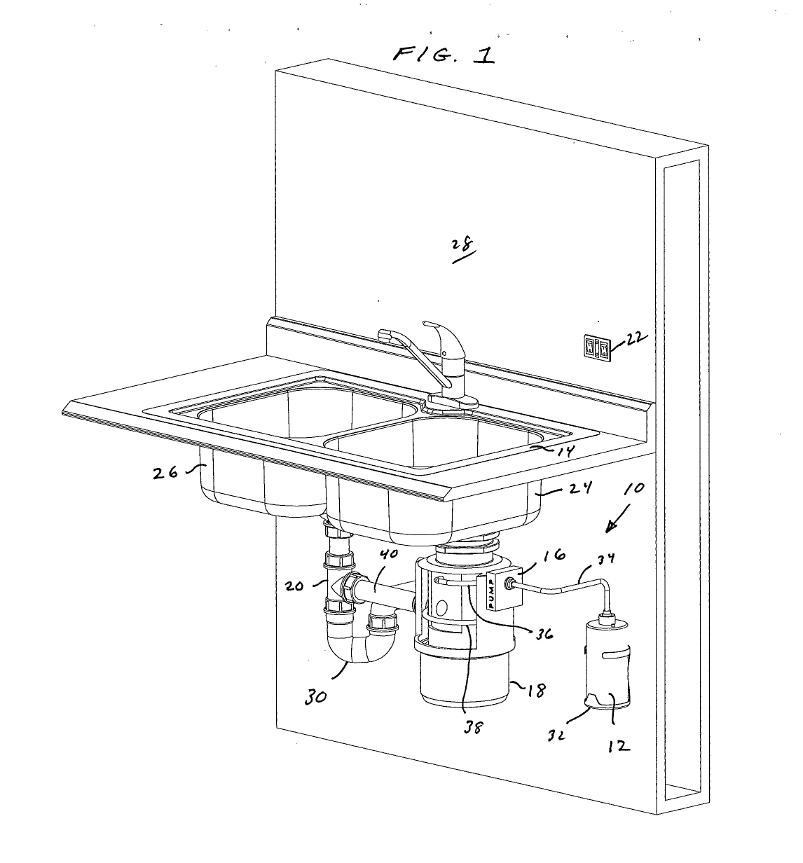

Turning to the drawings, there is shown in FIG. 1 one embodiment of the present invention, a garbage disposal treatment system for a double basin sink including a garbage disposal under one basin and an adjoining sink drain pipe under the other basin. The garbage disposal treatment system 10 comprises a reservoir 12 for holding a liquid, an electrically powered pump 16 for pumping the liquid into the garbage disposal 18 and further into the adjoining sink drain pipe 20, and an electrical switch 22 for activating the pump 16.

More generally, the system 10 is intended for use with a double basin sink 14 comprising first and second basins 24, 26 and mounted to a wall 28, counter or other structure, where the garage disposal 18 is mounted under the first basin 24 in fluid communication therewith and a sink drain pipe 20 having a P-trap 30 is mounted under the second basin 26 in fluid communication therewith.

The reservoir 12 preferably fits within a mounting bracket 32 or other type of holder mounted on the wall 28 under the sink 14, and should be easily removable from the mounting bracket 32 so that it can be easily refilled with liquid. A first conduit 34 extends between and connects the reservoir 12 to the pump 16, which may be mounted on the garbage disposal 18 or to any other available structure, such as the wall 28. A second conduit 36 extends between the pump 16 and one or more nozzles or ports (not shown) positioned inside the garbage disposal 18.

The liquid may be scented or unscented and may include any suitable sanitizing compound as well as deodorizing compounds, degreasing compounds and cleaning compounds. An optional light indicator mounted on the wall 28 above the sinks 24, 26 can be employed to indicate a low level of liquid in the reservoir 12 or an empty reservoir 12.

Preferably the nozzles inside the garbage disposal are positioned such that liquid sprayed from the nozzles impinges on the garbage disposal cutting blades, interior wall, and the underside of the flexible rubber splashguard located at the top of the garbage disposal where the sink drain guard would normally be located, since it has been determined that these areas are susceptible to bacteria and mold growth.

A third conduit 38 extends between the pump 16 and one or more nozzles or ports (not shown) positioned inside the sink drain pipe 20 underneath the second basin 26. This third conduit 38 may extend within a larger conduit or pipe 40 connecting the garbage disposal 18 to the sink drain pipe 20 so that the garbage disposal 18 and the sink drain pipe 20 are in fluid communication with each other. The one or more nozzles located within the sink drain pipe 20 are positioned to spray sanitizing fluid into the sink drain pipe 20 above the P-trap 30 so that some liquid will drain down into the P-trap to sanitize the water held in the P-trap 30.

The system can be set to one of a number of modes. In one (manual) mode the system 10 is activated by the switch 22 which can be located on the wall 28 or in any convenient location. The switch may be a toggle type switch 22 as shown, in which case the system 10, and more specifically the pump 16, will run for as long as the switch 22 is in the “on” position, or a button type switch (not shown) in which case the system 10/pump 16 is activated for only as long as the button is depressed.

In another (automatic) mode the system includes a timer means (not shown) and the switch 22 serves only to put the system 10 in an operating or non-operating mode. In the operating mode the system 10 automatically activates either during operation of the garbage disposal or a period of time after the garbage disposal 18 has been operated. For example, the timer means can be set so the pump 16 activates, say, ten seconds after the garbage disposal 18 has been operated and stays activated for any desired period, such as five more seconds. In the non-operating mode the system 10 is not automatically activated and instead is dormant.

In a third (hybrid) mode the system 10 can be automatically activated after the garbage disposal is operated as described above, but can also be manually activated when desired, for example, when extra sanitizing is needed.

In another (periodic) mode the system 10 operates periodically. For example, the system 10 can be set to automatically operate daily, every two days, four days, six days or any suitable period of time.

When activated, liquid from the reservoir 12 is pumped through the first conduit 34 and into second and third conduits 36, 38. Liquid pumped through the second conduit 36 exits the nozzles located inside the garbage disposal and impinges on the garbage disposal cutting blades, interior wall, and the underside of the flexible rubber splashguard. Liquid pumped through the third conduit 38 exits the one or more nozzles positioned inside the sink drain pipe 20 underneath the second basin 26 with some liquid ending up in the P-trap 30.

While the system 10 has heretofore been described for use with a double basin sink 14 having a garbage disposal 18 under one basin 24 and a drain pipe 20 under the second basin 26, the system 10 may also be used with other sink configurations.

For example, and without limitation, in one embodiment the system 10 may be used with a double basin sink 14 having drain pipes 20 under both basins 24, 26 but no garbage disposal, wherein the system 10 can be used to pump sanitizing liquid to the drain pipes 20 located under one or both sinks 24, 26.

In another embodiment, the system 10 may be used with a double basin sink 14 having a garbage disposal 18 under each basin 24, 26, wherein the system 10 can be used to pump sanitizing liquid into one or both garbage disposals 18.

In another embodiment, the system 10 may be used with a single basin sink having a garbage disposal 18, wherein the system 10 can be used to pump sanitizing liquid into the garbage disposal 18 as described above.

In yet another embodiment, the system 10 may be used with a single basin sink having a drain pipe 20 but no garbage disposal, wherein the system 10 can be used to pump sanitizing liquid into the drain pipe 20 as described above.

### Applications

The system 10 can be installed as original equipment or purchased as an aftermarket item and installed under an existing sink. In either case, the reservoir need not be mounted to a wall as shown in FIG. 1, but can be mounted to any suitable structure, including but not limited to the garbage disposal itself.

It should be understood that the embodiments of the invention described above are only particular examples which serve to illustrate the principles of the invention. Modifications and alternative embodiments of the invention are contemplated which do not depart from the scope of the invention as defined by the foregoing teachings and appended claims. It is intended that the claims cover all such modifications and alternative embodiments that fall within their scope.

I claim as my invention:

1. A treatment system for use with a sink having a garbage disposal mounted under the sink, the treatment system comprising:
a reservoir for holding a liquid;
a pump for pumping the liquid into the garbage disposal;
a switch for activating the pump.

2. The treatment system of claim 1 wherein:
the reservoir is removably mounted within a mounting bracket.

3. The treatment system of claim 2 further comprising:
a first conduit extending between and connecting the reservoir to the pump; and
a second conduit extending between the pump and one or more nozzles located inside the garbage disposal.

4. The treatment system of claim 1 wherein:
the liquid comprises a sanitizing compound.

5. The treatment system of claim 4 wherein:
the liquid further comprises a deodorizing compound and a degreasing compound.

6. The treatment system of claim 1 further comprising:
a light indicator to indicate a low level of liquid in the reservoir.

7. The treatment system of claim 1 wherein the sink is a double basin sink having first and second basins, the garbage disposal is mounted under the first basin and a drain pipe is mounted under the second basin, the system further comprising:
a third conduit extending between the pump and the drain pipe.

8. The treatment system of claim 7 wherein a P-trap is located downstream of the drain pipe, and wherein the third conduit extends between the pump and one or more nozzles located within the drain pipe above the P-trap.

9. The treatment system of claim 1 wherein the switch has an “on” position and an “off” position, and the pump is activated for only as long as the switch is in the “on” position.

10. The treatment system of claim 1 wherein the switch has an “on” position and an “off” position, and further comprising a timer which automatically activates the pump during operation of the garbage disposal when the switch is in the “on” position.

11. The treatment system of claim 1 wherein the switch has an “on” position and an “off” position, and further comprising a timer which activates the pump a predetermined period of time after the garbage disposal has been operated when the switch is in the “on” position.

12. The treatment system of claim 1 wherein the switch has an “on” position and an “off” position, and further comprising a timer which activates system periodically when the switch is in the “on” position.

13. The treatment system of claim 12 wherein the timer can be set to activate the pump daily.
